(19) United States
(12) Patent Application Publication
(10) Pub. No.: US 2014/0078753 A1
(43) Pub. Date: Mar. 20, 2014

(54) LUMINAIRE

(71) Applicant: TOSHIBA LIGHTING & TECHNOLOGY CORPORATION, Kanagawa (JP)

(72) Inventor: Tsutomu ARAKI, Kanagawa (JP)

(73) Assignee: Toshiba Lighting & Technology Corporation, Kanagawa (JP)

(21) Appl. No.: 13/710,113

(22) Filed: Dec. 10, 2012

(30) Foreign Application Priority Data
Sep. 18, 2012 (JP) 2012-204881

(51) Int. Cl. F21V 29/00

(52) U.S. Cl. CPC F21V 29/004
USPC 362/373

(57) ABSTRACT

According to one embodiment, a luminaire includes a housing, a light source provided at one end of the housing and including a light-emitting element, a cap section provided at an end of the housing on the opposite side of a side where the light source is provided, a substrate provided on the inside of the housing and including a lighting circuit, and a conducting section provided on the inside of the cap section and in contact with the substrate by an elastic force.

### CROSS-REFERENCE TO RELATED APPLICATIONS

This application is based upon and claims the benefit of priority from the prior Japanese Patent Application No. 2012-204881, filed on Sep. 18, 2012; the entire contents of which are incorporated herein by reference.

### FIELD

Embodiments described herein relate generally to a luminaire.

### BACKGROUND

There is a luminaire including a light-emitting diode and a lighting circuit configured to supply electric power to the light-emitting diode.

In such a luminaire, heat is generated from circuit components included in the light-emitting diode and the lighting circuit when the luminaire is lit.

The circuit components included in the lighting circuit are mounted on a substrate provided in a space in a housing. Therefore, heat generated in the circuit components is emitted to the outside via the space in the housing. It is likely that sufficient thermal radiation may not be able to be performed. On the other hand, if resin is filled in the space in the housing, thermal radiation of the heat generated in the circuit components can be improved. However, if the resin is filled in the space in the housing, a new problem occurs in that the weight of the luminaire increases.

### BRIEF DESCRIPTION OF THE DRAWINGS

FIG. 1 is a schematic sectional view for illustrating a luminaire according to a first embodiment;

FIG. 2 is a schematic sectional view for illustrating heat radiated via a housing; and

FIG. 3 is a schematic sectional view for illustrating a luminaire according to a second embodiment.

### DETAILED DESCRIPTION

In general, according to one embodiment, a luminaire includes: a housing; a light source provided at one end of the housing and including a light-emitting element; a cap section provided at an end of the housing on the opposite side of a side where the light source is provided; a substrate provided on the inside of the housing and including a lighting circuit; and a conducting section provided on the inside of the cap section and in contact with the substrate by an elastic force.

With the luminaire, it is possible to emit, via the conducting section, heat generated in circuit components included in the lighting circuit. Therefore, it is possible to improve radiation of the heat generated in the circuit components.

In the luminaire according to the embodiment, the cap section includes: a shell section including a thread ridge; an insulating section provided at an end of the shell section on the opposite side of an end on aside where the shell section is provided in the housing; and an eyelet section provided at an end of the insulating section on the opposite side of an end on a side where the insulating section is provided in the shell section. The conducting section is electrically connected to at least one of the eyelet section and the shell section.

With the luminaire, it is possible to efficiently emit the heat generated in the circuit components to the cap section via the conducting section. Therefore, it is possible to further improve the radiation of the heat generated in the circuit components.

In the luminaire according to the embodiment, a pair of the conducting sections are provided to be opposed to each other across the substrate.

With the luminaire, it is possible to hold the substrate with the two conducting sections. Therefore, it is possible to improve reliability for thermal connection and electrical connection.

In the luminaire according to the embodiment, a dimension between the two conducting sections is smaller than the thickness dimension of the substrate.

With the luminaire, it is possible to more surely hold the substrate with the two conducting sections. Therefore, it is possible to further improve the reliability for thermal connection and electrical connection.

In the luminaire according to the embodiment, a lead-in section including an inclined surface is provided at the distal end of the conducting section.

With the luminaire, it is possible to improve workability in attaching the substrate.

In the luminaire according to the embodiment, the substrate includes an input terminal of the lighting circuit in a position where the conducting section is in contact with the substrate.

With the luminaire, it is possible to perform electrical connection using the conducting section.

In the luminaire according to the embodiment, the housing includes: an inner layer section having insulation properties; a heat transfer layer provided on the outer side of the inner layer section and having heat conductivity higher than the heat conductivity of the inner layer section; an outer layer section provided on the outer side of the heat transfer layer and having insulation properties; and a first exposed section provided at an end of the housing on a side where the cap section is provided, the heat transfer layer being exposed from the first exposed section toward the outside of the housing. The heat transfer layer is connected to the cap section via the first exposed section.

With the luminaire, it is possible to emit the heat generated in the circuit components to the outside via the heat transfer layer.

The luminaire according to the embodiment further includes: a circuit component provided on the substrate and included in the lighting circuit; a second exposed section provided in the vicinity of the circuit component, the heat transfer layer being exposed from the second exposed section toward the inside of the housing; and a heat transfer section in contact with the circuit component and the second exposed section.

With the luminaire, it is possible to transfer heat generated in the circuit component to the heat transfer layer via the heat transfer section.

In the luminaire according to the embodiment, the heat conductivity of the heat transfer section is higher than the heat conductivity of the inner layer section.

With the luminaire, it is possible to efficiently transfer the heat generated in the circuit component to the heat transfer layer.

In the luminaire according to the embodiment, the heat conductivity of the heat transfer section is equal to or higher than 1 W/mk and equal to or lower than 5 W/mk.

With the luminaire, it is possible to efficiently transfer the heat generated in the circuit component to the heat transfer layer.

In general, according to another embodiment, a luminaire includes: a housing including: an inner layer section having insulation properties; a heat transfer layer provided on the outer side of the inner layer section and having heat conductivity higher than the heat conductivity of the inner layer section; and an outer layer section provided on the outer side of the heat transfer layer and having insulation properties; a light source provided at one end of the housing and including a light-emitting element; and a substrate provided on the inside of the housing and including a lighting circuit.

With the luminaire, it is possible to emit heat generated in circuit components to the outside via the heat transfer layer.

The luminaire according to the embodiment further includes: a circuit component provided on the substrate and included in the lighting circuit; a second exposed section provided in the vicinity of the circuit component, the heat transfer layer being exposed from the second exposed section toward the inside of the housing; and a heat transfer section in contact with the circuit component and the second exposed section.

With the luminaire, it is possible to transfer heat generated in the circuit component to the heat transfer layer via the heat transfer section.

In the luminaire according to the embodiment, the heat conductivity of the heat transfer section is higher than the heat conductivity of the inner layer section.

With the luminaire, it is possible to efficiently transfer the heat generated in the circuit component to the heat transfer layer.

In the luminaire according to the embodiment, the heat conductivity of the heat transfer section is equal to or higher than 1 W/mk and equal to or lower than 5 W/mk.

With the luminaire, it is possible to efficiently transfer the heat generated in the circuit component to the heat transfer layer.

Embodiments are illustrated below with reference to the accompanying drawings. In the drawings, the same components are denoted by the same reference numerals and signs and detailed explanation of the components is omitted as appropriate.

### First Embodiment

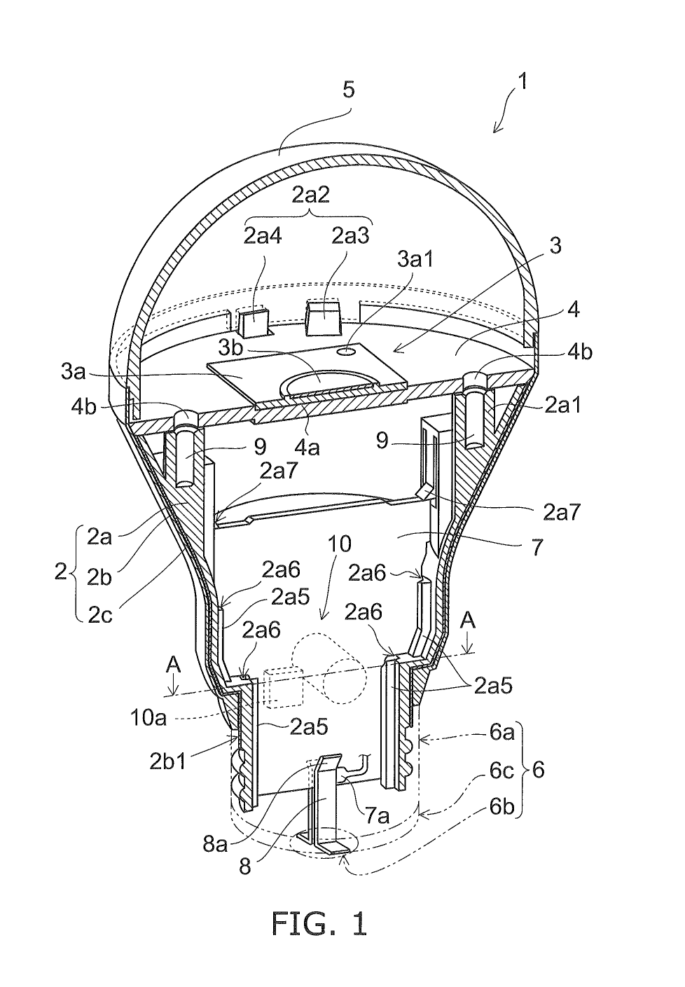

FIG. 1 is a schematic sectional view for illustrating a luminaire according to a first embodiment.

As shown in FIG. 1, a luminaire 1 includes a housing 2, a light source 3, a thermal radiation plate 4, a globe 5, a cap section 6, a substrate 7, and a conducting sections 8.

The housing 2 can be formed in, for example, a shape in which a sectional area in a direction perpendicular to the axis direction thereof increases from the cap section 6 side toward the globe 5 side. However, the housing 2 is not limited to this shape. The shape can be changed as appropriate according to, for example, the sizes of the light source 3 and the globe 5 or the size of the cap section 6. In this case, if the shape is approximated to the shape of a neck portion of an incandescent lamp, it is easy to replace the existing incandescent lamp with the luminaire 1.

The housing 2 includes an inner layer section 2a, a heat transfer layer 2b, and an outer layer section 2c.

The inner layer section 2a is located on the inner side of the housing 2. The inner layer section 2a has a cylindrical shape opened at both ends.

The inner side of the inner layer section 2a is a space for holding the substrate 7. The inner layer section 2a is formed of resin having insulation properties such as PBT (polybutylene terephthalate) resin. As explained below, the heat transfer layer 2b is sometimes formed of a conductive material such as metal. Therefore, since the inner layer section 2a has insulation properties, it is possible to secure insulation between the substrate 7 and the heat transfer layer 2b and between circuit components 10 mounted on the substrate 7 and the heat transfer layer 2b.

A boss section 2a1 is provided at one end (an end on the globe 5 side) of the inner layer section 2a. A plurality of screw holes 9 for screwing the thermal radiation plate 4 are provided in the boss section 2al. For example, two screw holes 9 can be provided in positions symmetrical with respect to the center of the housing 2. However, the number, the arrangement, and the like of the screw holes 9 are not limited to those explained above and can be changed as appropriate.

A plurality of attachment sections 2a2 for attaching the globe 5 are provided at an end of the inner layer section 2a on a side where the boss section 2a1 is provided. For example, three attachment sections 2a2 can be provided at equal intervals in the circumferential direction of the inner layer section 2a. However, the number, the arrangement, and the like of the attachment sections 2a2 are not limited to those explained above and can be changed as appropriate.

The attachment sections 2a2 include protrusions 2a3 used for positioning of the globe 5 and claws 2a4 used for holding the globe 5.

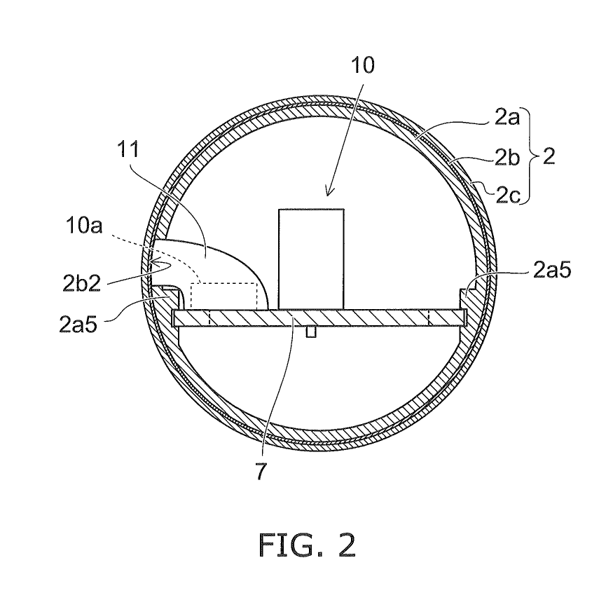

Substrate holding sections 2a5 that hold the substrate 7 are provided on the inner side of the inner layer section 2a. The substrate holding sections 2a5 are provided on the cap section 6 side of the inner layer section 2a. The substrate holding sections 2a5 extend in the axis direction of the inner layer section 2a. Grooves 2a6 for holding the substrate 7 are provided in the substrate holding sections 2a5. A pair of the substrate holding sections 2a5 are provided to oppose the grooves 2a6 against each other. The pair of substrate holding sections 2a5 are provided in positions offset with respect to the center of the inner layer section 2a (see FIG. 2).

Claws 2a7 for preventing the substrate 7 held by the substrate holding sections 2a5 from coming off are provided on the inner side of the inner layer section 2a. The claws 2a7 are provided at a distal end of an elastic beam, one end of which is a free end. Therefore, when the substrate 7 is inserted into the grooves 2a6, the claws 2a7 are pushed by the substrate 7 to move toward the outer side of the inner layer section 2a. When the insertion of the substrate 7 ends, the claws 2a7 project toward the inner side of the inner layer section 2a with an elastic force. An end of the substrate 7 is pressed by the claws 2a7.

The heat transfer layer 2b is provided on the outer side of the inner layer section 2a. The heat transfer layer 2b is provided to cover the outer surface of the inner layer section 2a. The heat transfer layer 2b has a cylindrical shape opened at both ends.

The heat transfer layer 2b is formed of a material having high heat conductivity. For example, the heat transfer layer 2b has heat conductivity higher than the heat conductivity of the inner layer section 2a. The heat transfer layer 2b can be formed of metal such as aluminum (Al), copper (Cu), or an alloy of aluminum and copper. However, the heat transfer layer 2b is not limited to these kinds of metal and can be formed of an inorganic material such as aluminum nitride (AlN), an organic material such as high thermal conductive resin, or the like as well.

At least a part of an end of the heat transfer layer 2b on the cap section 6 side is exposed from the outer layer section 2c. In other words, an exposed section 2b1 (equivalent to an example of the first exposed section) of the heat transfer layer 2b is a portion where the heat transfer layer 2b is exposed toward the outside of the housing 2. The exposed section 2b1 of the heat transfer layer 2b is thermally connected to the cap section 6. For example, the exposed section 2b1 and the cap section 6 can be set in contact with each other. The exposed section 2b1 and the cap section 6 can be joined via an adhesive, solder, or the like having high heat conductivity.

As explained above, the heat transfer layer 2b is connected to the cap section 6 via the exposed section 2b1.

An end face of the heat transfer layer 2b on the globe 5 side is thermally connected to the thermal radiation plate 4. For example, the end face of the heat transfer layer 2b on the globe 5 side and the thermal radiation plate 4 can be set in contact with each other. The end face of the heat transfer layer 2b on the globe 5 side and the thermal radiation plate 4 can be joined via an adhesive, solder, or the like having high heat conductivity.

The outer layer section 2c is located on the outer side of the housing 2. The outer layer section 2c is provided on the outer side of the heat transfer layer 2b. The outer layer section 2c is provided to cover the outer surface of the heat transfer layer 2b. The outer layer section 2c has a cylindrical shape opened at both ends.

The outer layer section 2c is formed of resin having insulation properties such as PBT resin. As explained above, the heat transfer layer 2b is sometimes formed of a conductive material such as metal. When the heat transfer layer 2b is thermally connected to the cap section 6 via the exposed section 2b1, the heat transfer layer 2b is sometimes connected to the cap section 6 electrically as well. Therefore, the outer layer section 2c having insulation properties is provided.

The light source 3 includes a module substrate 3a and a light-emitting section 3b.

The module substrate 3a can be a tabular body having a rectangular shape. The module substrate 3a is formed of a material having high heat conductivity. The module substrate 3a can be formed of, for example, metal such as aluminum or an inorganic material such as aluminum nitride. A plurality of holes 3a1 for screwing the module substrate 3a to the thermal radiation plate 4 are provided in the module substrate 3a.

A wiring pattern is formed on one surface of the module substrate 3a. Light-emitting elements, a connector, and the like provided in the light-emitting section 3b are mounted on the wiring pattern.

The light-emitting section 3b is provided on a side of the module substrate 3a where the wiring pattern is provided.

The light-emitting elements are provided in the light-emitting section 3b. The number of the light-emitting elements provided in the light-emitting section 3b is not specifically limited. One or more light-emitting elements only have to be provided according to a use of the luminaire 1, the size of the light-emitting elements, and the like.

The light-emitting elements can be, for example, so-called self-emitting elements such as light-emitting diodes, organic light-emitting diodes, or laser diodes. If a plurality of light-emitting elements are provided in the light-emitting section 3b, a regular disposing form such as a matrix shape, a zigzag shape, or a radial shape can be adopted or an arbitrary disposing form can be adopted.

In the light-emitting section 3b, a chip on board (COB) system can be adopted in which the plurality of light-emitting elements are collectively mounted on one surface of the module substrate 3a. In this case, for example, the plurality of light-emitting elements can be mounted on a side of the module substrate 3a where the wiring pattern is provided and can be electrically connected in series using a wire bonding method.

The plurality of light-emitting elements mounted on the surface of the module substrate 3a are covered with resin including a phosphor. The resin can be, for example, resin containing silicone as a main component. The phosphor can be, for example, a YAG phosphor (yttrium aluminum garnet phosphor).

If the light-emitting elements are blue light-emitting diodes and the phosphor is the YAG phosphor, the YAG phosphor is excited by blue light emitted from the light-emitting elements. Yellow fluorescence is radiated from the YAG phosphor. The blue light and the yellow light are mixed, whereby white light is emitted from the light-emitting section 3b. The phosphor is not limited to the YAG phosphor and can be changed as appropriate such that a desired light emission color is obtained according to a use of the luminaire 1 or the like.

The thermal radiation plate 4 is provided at an end of the housing 2 on a side where the globe 5 is provided. The thermal radiation plate 4 assumes a disk shape and is formed of a material having high heat conductivity. The thermal radiation plate 4 can be formed of, for example, metal such as aluminum or an inorganic material such as aluminum nitride. A recess 4a is provided on a surface of the thermal radiation plate 4 on the globe 5 side. The module substrate 3a of the light-emitting section 3b is fit in the recess 4a.

Holes 4b through which screws for attaching the thermal radiation plate 4 to the housing 2 are inserted are provided in the thermal radiation plate 4. The holes 4b are provided in positions corresponding to the screw holes 9 provided in the boss section 2a1.

The globe 5 is provided to cover the light source 3. The globe 5 can be a globe having a curved surface projecting in a light radiating direction.

The globe 5 has translucency such that light radiated from the light source 3 can be emitted to the outside of the luminaire 1. The globe 5 can be a globe formed of a translucent material. For example, the globe 5 can be formed of, for example, glass or transparent resin such as polycarbonate. A diffusing agent, a phosphor, or the like can be applied to the inner surface of the globe 5 or can be included in the inside of the globe 5 according to necessity.

The cap section 6 is provided at an end of the housing 2 on the opposite side of a side where the light source 3 is provided. The cap section 6 can be a cap section having a shape attachable to a socket to which an incandescent lamp is connected. The cap section 6 can be, for example, a cap section having a shape same as the E26 type or the E17 type specified by the JIS standard.

The cap section 6 includes a shell section 6a, an eyelet section 6b, and an insulating section 6c.

The shell section 6a assumes a cylindrical shape and includes a screw ridge on the outer side.

The insulating section 6c is provided at an end of the shell section 6a on the opposite side of an end on a side where the shell section 6a is provided in the housing 2.

The eyelet section 6b is provided at an end of the insulating section 6c on the opposite side of an end on a side where the insulating section 6c is provided in the shell section 6a.

The shell section 6a and the eyelet section 6b are formed of a conductive material such as aluminum.

The insulating section 6c is formed of an insulative material such as resin.

The shell section 6a is connected via a not-shown wire to a lighting circuit provided on the substrate 7.

The eyelet section 6b is connected via the conducting sections 8 explained below to a lighting circuit provided on the substrate 7.

The substrate 7 is provided on the inside of the housing 2 and includes the lighting circuit. The lighting circuit supplies electric power to the light-emitting elements provided in the light-emitting section 3b.

The width dimension on the globe 5 side of the substrate 7 is larger than the width dimension on the cap section 6 side. If the width dimension on the globe 5 side is increased, a space for mounting the circuit components 10 included in the lighting circuit can be increased.

The circuit components 10 included in the lighting circuit are, for example, an electrolytic capacitor used in a rectifying and smoothing circuit that rectifies and smoothes an alternating-current voltage, an inductor used in a chopper circuit that converts the rectified and smoothed voltage into a predetermined voltage, a switching element used in the chopper circuit, a discrete component, a resistor, a capacitor, a diode, a chip resistor, and a chip capacitor. However, the circuit components 10 are not limited to the illustrated components and can be changed as appropriate.

A wiring pattern included in the lighting circuit is provided on the substrate 7. An input terminal 7a is provided in the wiring pattern. As explained below, the conducting sections 8 are in contact with the input terminal 7a. Therefore, if the size of the input terminal 7a is set too small, it is likely that electrical connection is deteriorate. For example, the input terminal 7a can be formed in a rectangular shape, the length dimension of one side of which is equal to or larger than 2 millimeters.

As explained above, the substrate 7 includes the input terminal 7a of the lighting circuit in a position where the conducting sections 8 are in contact with the substrate 7.

The conducting sections 8 are provided on the inside of the cap section 6.

The conducting sections 8 are connected to the eyelet section 6b. In this case, the conducting sections 8 are electrically and thermally connected to the eyelet section 6b. For example, the conducting sections 8 can be welded to the eyelet section 6b or can be soldered to the eyelet section 6b. The conducting sections 8 can be connected to the eyelet section 6b via a member having electric conductivity.

The conducting sections 8 can be formed of a material having electric conductivity and elasticity. The conducting sections 8 can be formed of, for example, stainless steel or beryllium copper.

The conducting sections 8 are in contact with the substrate 7 by an elastic force. Since the conducting sections 8 are in contact with the substrate 7, the conducting sections 8 and the substrate 7 is thermally and electrically connected.

In the luminaire 1 illustrated in FIG. 1, two conducting sections 8 assuming a tabular shape are provided. A dimension between the two conducting sections 8 is set smaller than the thickness dimension of the substrate 7. The two conducting sections 8 are provided to be opposed to each other across the substrate 7. Therefore, it is possible to hold the substrate 7 with the two conducting sections 8. One conducting section 8 may be provided or three or more conducting sections 8 may be provided. In this case, if a plurality of conducting sections 8 are provided to hold the substrate 7, reliability for thermal and electrical connection can be improved.

The conducting sections 8 are in contact with the input terminal 7a of the wiring pattern included in the lighting circuit. In this case, the input terminal 7a only has to be provided on one surface of the substrate 7. However, if a pair of input terminals 7a are provided on both surfaces, reliability for electrical connection can be improved. If the input terminals 7a are provided on both the surfaces of the substrate 7, it is possible to electrically connect the input terminals 7a provided on both the surfaces of the substrate 7 by providing a through-hole in the substrate 7.

Lead-in sections 8a including inclined surfaces are provided at distal ends of the conducting sections 8. If the lead-in sections 8a are provided, it is possible to improve workability in attaching the substrate 7.

The form of the conducting sections 8 is not limited to the form illustrated in FIG. 1 and can be changed as appropriate. The form of the conducting sections 8 is not specifically limited as long as the conducting sections 8 can be in contact with the substrate 7 by an elastic force.

As explained above, the substrate 7 and the eyelet section 6b are electrically and thermally connected via the conducting sections 8.

Therefore, heat generated in the circuit components 10 can be transferred to the cap section 6 via the substrate 7 and the conducting sections 8. In this case, since the conducting sections 8 assume a tabular shape, for example, a transferrable quantity of heat can be increased compared with, for example, a quantity of heat transferred via a wire.

Therefore, it is possible to improve thermal radiation of the heat generated in the circuit components 10.

In the above explanation, the heat generated in the circuit components 10 is radiated via the cap section 6.

In the following explanation, the heat generated in the circuit components 10 is radiated via the housing 2.

FIG. 2 is a schematic sectional view for illustrating heat radiated via the housing 2.

FIG. 2 is an A-A arrow sectional view in FIG. 1.

A part of the heat generated in the circuit components 10 is radiated via the substrate 7, the conducting sections 8, and the cap section 6. The remaining part of the heat generated in the circuit components 10 is radiated to the outside via a space in the housing 2. Therefore, it is likely that thermal radiation is deteriorated. In this case, if resin is filled in the space in the housing 2, it is possible to improve the thermal radiation of the heat generated in the circuit component 10. However, if the resin is filled in the space in the housing 2, a new problem occurs in that the weight of the luminaire 1 increases.

As the circuit components 10, there are a circuit component having a large heat value and a circuit component having a small heat value. For example, an integrated circuit for control has a large heat value. Therefore, if thermal radiation concerning only a circuit component 10a having a large heat value is improved, it is possible to suppress the weight of the luminaire 1 from increasing.

In this embodiment, as shown in FIG. 2, a hole is provided in the inner layer section 2a to expose the heat transfer layer 2b in the vicinity of the circuit component 10a having a large heat value. In other words, an exposed section 2b2 (equivalent to an example of the second exposed section) is provided in the vicinity of the circuit component 10a. In the exposed section 2b2, the heat transfer layer 2b is exposed toward the inside of the housing 2. A heat transfer section 11 is provided that covers the circuit component 10a and is in contact with the exposed section 2b2 of the heat transfer layer 2b.

The heat transfer section 11 can be formed of a material having high heat conductivity. The heat transfer section 11 has heat conductivity higher than the heat conductivity of the inner layer section 2a.

The heat transfer section 11 can be formed of, for example, silicone resin having heat conductivity equal to or higher than 1 W/mk and equal to or lower than 5 W/mk.

The heat transfer section 11 can be formed as explained below.

First, the substrate 7 mounted with the circuit component 10a is placed on the inside of the housing 2. The substrate 7 is inserted into the grooves 2a6 of the substrate holding sections 2a5. The substrate 7 inserted into the grooves 2a6 is held by the substrate holding sections 2a5 and prevented from slipping out by the claws 2a7.

Subsequently, a nozzle is inserted from an opening at an end of the housing 2. Silicone resin or the like is supplied to cover the circuit component 10a and come into contact with the exposed section 2b2 of the heat transfer layer 2b. The supplied silicone resin or the like is naturally dried to be hardened to form the heat transfer section 11.

If such a heat transfer section 11 is provided, it is possible to suppress the weight of the luminaire 1 from increasing and improve thermal radiation.

In the above explanation, the heat transfer section 11 is provided to cover the circuit component 10a. However, it is not always necessary to provide the heat transfer section 11 to cover the circuit component 10a. For example, the heat transfer section 11 only has to be provided between the circuit component 10a and the exposed section 2b2 of the heat transfer layer 2b to allow the heat generated in the circuit component 10a to be transferred to the heat transfer layer 2b via the heat transfer section 11.

In other words, the heat transfer section 11 only has to be a heat transfer section in contact with the circuit component 10a and the exposed section 2b2.

The exposed section 2b2 of the heat transfer layer 2b may be provided in one place or a plurality of exposed sections 2b2 may be provided in a plurality of places.

It is also possible to provide the heat transfer section 11 that covers a plurality of circuit components 10a and provide a plurality of heat transfer sections 11 respectively between the plurality of circuit components 10a and the plurality of exposed sections 2b2.

### Second Embodiment

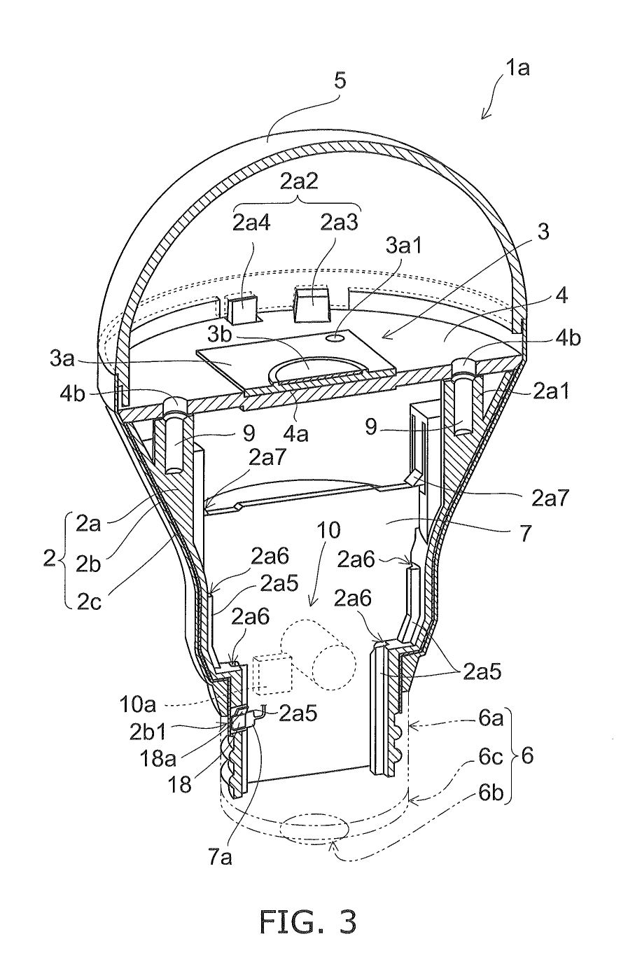

FIG. 3 is a schematic sectional view for illustrating a luminaire according to a second embodiment.

As shown in FIG. 3, a luminaire la includes the housing 2, the light source 3, the thermal radiation plate 4, the globe 5, the cap section 6, the substrate 7, and conducting sections 18.

As shown in FIG. 3, the conducting sections 18 are connected to the shell section 6a.

For example, the conducting sections 18 are provided in a position where the substrate holding sections 2a5 are provided. The conducting sections 18 are connected to the heat transfer layer 2b exposed to the hole provided in the inner layer section 2a. Since the heat transfer layer 2b can be formed of metal such as aluminum, it is possible to connect the conducting sections 18 to the shell section 6a via the heat transfer layer 2b. A hole that pierces through the housing 2 may be provided to directly connect the conducting sections 18 to the shell section 6a.

The conducting sections 18 are electrically and thermally connected to the shell section 6a. For example, the conducting sections 18 can be welded to the heat transfer layer 2b or the shell section 6a or can be soldered to the heat transfer layer 2b or the shell section 6a.

Lead-in sections 18a including inclined surfaces are provided at the distal ends of the conducting sections 18. If the lead-in sections 18a are provided, it is possible to improve workability in attaching the substrate 7.

The conducting sections 18 are in contact with the substrate 7 by an elastic force.

In the luminaire 1a illustrated in FIG. 3, two conducting sections 18 assuming a tabular shape are provided. A dimension between the two conducting sections 18 is set smaller than the thickness dimension of the substrate 7. The two conducting sections 18 are provided to be opposed to each other across the substrate 7. Therefore, it is possible to hold the substrate 7 with the two conducting sections 18. Since the conducting sections 18 are in contact with the substrate 7, the conducting sections 18 are thermally and electrically connected to the substrate 7. One conducting section 18 may be provided or a plurality of conducting sections 18 may be provided. In this case, if the plurality of conducting sections 18 are provided to hold the substrate 7, reliability for thermal and electrical connection can be improved.

In the luminaire 1a illustrated in FIG. 3, the conducting sections 18 are provided on one end side in the width direction of the substrate 7. However, a place where the conducting sections 18 are provided is not limited to this. The conducting sections 18 can be provided on an end side opposed to the substrate 7 as well or can be respectively provided on both the end sides of the substrate 7 as well.

The material, the form, and the like of the conducting sections 18 can be the same as those of the conducting sections explained above. Therefore, detailed explanation concerning the material, the form, and the like of the conducting sections 18 is omitted.

Even when the conducting sections 18 are connected to the shell section 6a, it is possible to improve thermal radiation of heat generated in the circuit components 10.

In this case, the heat generated in the circuit components 10 is transferred to the cap section 6 and the heat transfer layer 2b via the conducting sections 18 and emitted to the outside.

As explained above, the conducting section only have to be connected to at least one of the eyelet section 6b and the shell section 6a.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A luminaire comprising:
a housing;
a light source provided at one end of the housing and including a light-emitting element;
a cap section provided at an end of the housing on an opposite side of a side where the light source is provided;
a substrate provided on an inside of the housing and including a lighting circuit; and
a conducting section provided on an inside of the cap section and in contact with the substrate by an elastic force.

2. The luminaire according to claim 1, wherein
the cap section includes:
a shell section including a thread ridge;
an insulating section provided at an end of the shell section on an opposite side of an end on a side where the shell section is provided in the housing; and
an eyelet section provided at an end of the insulating section on an opposite side of an end on a side where the insulating section is provided in the shell section, and
the conducting section is electrically connected to at least one of the eyelet section and the shell section.

3. The luminaire according to claim 1, wherein a pair of the conducting sections are provided to be opposed to each other across the substrate.

4. The luminaire according to claim 3, wherein a dimension between the two conducting sections is smaller than a thickness dimension of the substrate.

5. The luminaire according to claim 1, wherein a lead-in section including an inclined surface is provided at a distal end of the conducting section.

6. The luminaire according to claim 1, wherein the substrate includes an input terminal of the lighting circuit in a position where the conducting section is in contact with the substrate.

7. The luminaire according to claim 1, wherein
the housing includes:
an inner layer section having insulation properties;
a heat transfer layer provided on an outer side of the inner layer section and having heat conductivity higher than heat conductivity of the inner layer section;
an outer layer section provided on an outer side of the heat transfer layer and having insulation properties; and
a first exposed section provided at an end of the housing on a side where the cap section is provided, the heat transfer layer being exposed from the first exposed section toward an outside of the housing, and
the heat transfer layer is connected to the cap section via the first exposed section.

8. The luminaire according to claim 7, further comprising:
a circuit component provided on the substrate and included in the lighting circuit;
a second exposed section provided in a vicinity of the circuit component, the heat transfer layer being exposed from the second exposed section toward the inside of the housing; and
a heat transfer section in contact with the circuit component and the second exposed section.

9. The luminaire according to claim 8, wherein heat conductivity of the heat transfer section is higher than heat conductivity of the inner layer section.

10. The luminaire according to claim 8, wherein the heat conductivity of the heat transfer section is equal to or higher than 1 W/mk and equal to or lower than 5 W/mk.

11. A luminaire comprising:
a housing including:
an inner layer section having insulation properties;
a heat transfer layer provided on an outer side of the inner layer section and having heat conductivity higher than heat conductivity of the inner layer section; and
an outer layer section provided on an outer side of the heat transfer layer and having insulation properties;
a light source provided at one end of the housing and including a light-emitting element; and
a substrate provided on an inside of the housing and including a lighting circuit.

12. The luminaire according to claim 11, further comprising:
a circuit component provided on the substrate and included in the lighting circuit;
a second exposed section provided in a vicinity of the circuit component, the heat transfer layer being exposed from the second exposed section toward an inside of the housing; and
a heat transfer section in contact with the circuit component and the second exposed section.

13. The luminaire according to claim 12, wherein heat conductivity of the heat transfer section is higher than heat conductivity of the inner layer section.

14. The luminaire according to claim 12, wherein the heat conductivity of the heat transfer section is equal to or higher than 1 W/mk and equal to or lower than 5 W/mk.

15. A method of dissipating heat in a luminaire having a housing, a light source provided at a first end of the housing and including a light-emitting element, a cap section provided at a second end of the housing, and a substrate provided inside of the housing and including a lighting circuit, wherein the housing includes an inner heat insulation layer, a heat transfer layer provided on an outer side of the inner heat insulation layer, and an outer heat insulation layer provided on an outer side of the heat transfer layer, comprising:
transferring heat generated by the lighting circuit through the heat transfer layer; and
dissipating the transferred heat through the cap section.

16. The method of claim 15, wherein the inner heat insulation layer has an opening that exposes the heat transfer layer, and the cap section and the portion of the heat transfer layer that is exposed by the opening are in direct thermal contact.

17. The method of claim. 16, wherein the inner heat insulation layer has a second opening that exposes the heat transfer layer to the lighting circuit, and the heat generated by the lighting circuit is conducted away by the portion of the heat transfer layer that is exposed by the second opening.

18. The method of claim. 17, wherein a heat generating element of the lighting circuit is embedded in a heat transfer section and the heat transfer section and the portion of the heat transfer layer that is exposed by the second opening are in direct thermal contact.

19. The method of claim 18, wherein the cap section includes an electrically conducting section that is mounted elastically with respect to the substrate.

20. The method of claim 19, wherein the transferred heat is dissipated through the electrically conducting section.
